(19) United States
(12) Patent Application Publication
(10) Pub. No.: US 2003/0147752 A1
(43) Pub. Date: Aug. 7, 2003

(54) Air impellor

(76) Inventors: Dirk-Olaf Leimann, Antwerp (BE); Peter Flamang, Antwerp (BE); Thierry De Munck, Antwerp (AU)

Correspondence Address: YOUNG & THOMPSON, 745 SOUTH 23RD STREET 2ND FLOOR, ARLINGTON, VA, 22202

(21) Appl. No.: 10/240,777

(22) PCT Filed: Apr. 5, 2001
(86) PCT No.: PCT/IB01/00669

(30) Foreign Application Priority Data
Apr. 5, 2000 (GB) 0008296.6

(51) Int. Cl. F03B 3/12

(52) U.S. Cl. 416/204 R

(57) ABSTRACT

An air impellor comprises a sheet of plastically deformable material having a plurality of cuts which each extend radially outwards from a central position defined by the intersection between said sheet of material and an axis about which, in use, the impellor is intended to rotate, each cut extending to an outer boundary edge (17) of the sheet material from an inner end base region which lies at a position spaced radially outwards from said central position, each vane segment (11) thereby defined by the sheet material lying between each successive pair of cuts having a twisted profile in which the local angle of inclination of a circumferentially extending line on said vane segment as considered relative to a plane perpendicular to said axis of rotation increases with increasing radial distance of the circumferentially extending line from said axis of rotation. The invention provides also a method of constructing an air impellor and a geared assembly comprising a shaft associated with a gear train and having an air impellor of the invention secured thereto.

This invention relates to an air impellor and in particular, although not exclusively, to an air impellor of a simple construction and suitable for use in an environment in which it is subject to vibration from a gear train.

The invention relates also, but again not exclusively, to an air impellor of a construction which allows a single impellor to be adapted readily to provide a selected type of air flow pattern and/or allow a choice of means of attachment to a drive shaft.

Many different designs of axial and radial flow air impellor fans are available and, typically, comprise impellors manufactured from moulded plastics material or cast metal. Almost invariably they have to be preformed to a particular size and shape, and have a predetermined type of attachment means for securing to a shaft of a gear train.

Particularly for use in the cooling of industrial gear units it has been common to employ a fan which provides a radial airflow, these fans having the advantage over axial fans of providing an air flow which is independent of the direction of rotation of the fan impellor. However radial fans are less efficient than axial fans and require a special housing or duct in order to provide a flow of cooling air in a required direction.

Another constraint arising in the design of an air impellor, especially one suitable for use in an operating environment in which it is subject to the vibration of a gear train, is that of ensuring that the impellor does not develop fatigue cracks.

The present invention seeks to provide an air impellor and method of manufacture of an air impellor which mitigates or overcomes at least some of the aforedescribed disadvantages or limitations of existing forms of construction of air impellors.

In accordance with one aspect of the present invention a method for constructing an air impellor comprises providing a substantially planar sheet of plastically deformable material, forming in said sheet a plurality of cuts which each extend radially outwards from a central position defined by the intersection between said plane of the sheet material and an axis perpendicular to said plane and about which, in use, the impellor is intended to rotate, each cut extending to an outer boundary edge of the sheet material from an inner end base region which lies at a position spaced radially outwards from said central position, and then plastically deforming each segment of sheet material lying between each successive pair of cuts whereby each segment is given a twisted profile to form a vane segment in which the local angle of inclination, relative to said plane, of a circumferentially extending line on said segment increases with increasing radial distance of the circumferentially extending line from said central position

In accordance with another aspect of the present invention there is provided an air impellor comprising a sheet of plastically deformable material having a plurality of cuts which each extend radially outwards from a central position defined by the intersection between said sheet of material and an axis about which, in use the impellor is intended to rotate, each cut extending to an outer boundary edge of the sheet material from an inner end base region which lies at a position spaced radially outwards from said central position, each vane segment thereby defined by the sheet material lying between each successive pair of cuts having a twisted profile in which the local angle of inclination of a circumferentially extending line on said vane segment, as considered relative to a plane perpendicular to said axis of rotation, increases with increasing radial distance of the circumferentially extending line from said axis of rotation.

Preferably each vane segment lies substantially symmetrically disposed about a plane perpendicular to said axis of rotation. Each segment may have a line of symmetry which extends rectilinearly in said plane. It is preferred also that each vane is of the same size and twist profile.

The air impellor preferably has at least four vane segments, more preferably at least twelve segments.

It is further preferred that the angle of inclination increases progressively over at least 50% of the radial length of each vane segment, at least in the case of an air impellor intended to act as an axial flow impellor fan. Said angle may increase progressively over substantially the whole of said radial length.

The radially extending cuts may each be of the same radial extent. The vane segments may each be of the same shape and dimensions.

The cut separating a successive pair of vane segments may be formed by a stamping operation which optionally may simultaneously remove unwanted material from the sheet for a purpose described below. Examples of other techniques for forming the cut include laser cutting and electro-chemical or spark erosion

An example of a suitable plastically deformable sheet material is sheet steel. Sheet material may be deformed to shape the vane segments by, for example, a hot or cold forming technique.

At least at the inner end base region of each cut it is preferred that the edges of the vanes are undercut such that the sheet material has a smooth curved profile, thereby to minimise or avoid the risk of unduly high and potentially damaging stress concentration zones arising

Optionally, for an impellor fan to be mounted around a shaft, a central zone of the sheet material is removed, e.g. by a stamping operation. In that case sheet material surrounding the resulting central opening may be deformed, e.g. by hot or cold forming, to provide a substantially cylindrical location sleeve for location on a drive shaft. Alternatively or additionally the sheet material surrounding said central opening may be provided with a plurality of circumferentially spaced holes for example to allow the impellor fan to be bolted to a location flange carried by a drive shaft. A central opening may be given a dimension which is closely toleranced to ensure that said opening can cooperate with a shaft or, for example, a location sleeve carried by a shaft so as to provide a centralised and balanced location of the impellor shaft.

The vane segments preferably lie wholly at an inclination angle less than 90 degrees in the case of an impellor fan which is to provide an axial flow of air.

In the case of an impellor fan which is to provide a radial flow of air, preferably the inclination angle of each vane segment is greater than 45 degrees over at least 50% of the radial extent of each cut; preferably the inclination angle is at least 80 degrees, more preferably at least 85 degrees, at the radially outer edge of each segment.

For an impellor fan which is to provide an axially directed flow of air it is preferred that each vane segment is deformed at the radially outer end thereof to form a deflector that will reduce the tendency for air to flow radially outwards and thereby adversely affect operating efficiency.

The invention further provides a gearbox assembly and a geared motor assembly in which a shaft associated with the gear train has secured thereto an impellor fan of a type in accordance with the invention.

Embodiments of the invention will now be described with reference to the accompanying diagrammatic drawings.

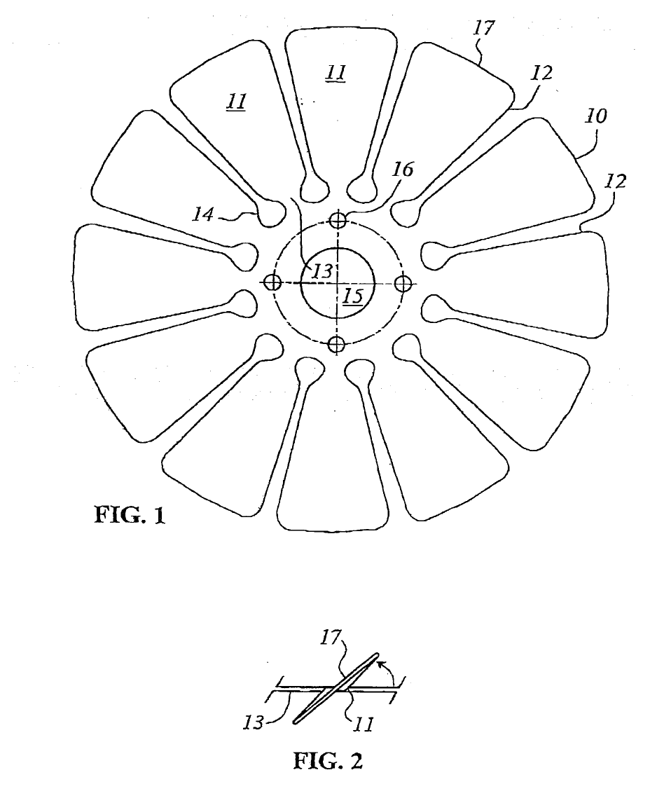

FIG. 1 shows in plan a flat sheet 10 of stamped steel shaped to provide twelve vane segments 11. The stamping operation to shape the sheet 10 removes a small amount of material between adjacent radially extending edges 12 of the successive segments.

At a base region 13 the stamping operation removes a greater width of material and results in a curved profile 14 which assists in minimising stress concentration.

The sheet 10 has a central aperture 15 for mounting around a drive shaft (not shown) of a geared motor, and that is surrounded by four circumferentially spaced location holes 16 for optional mounting to a collar carried by a drive shaft.

To form an impellor from the sheet 10 each vane segment 11 is twisted as shown in FIG. 2 which is an end view of a vane segment. The angle of inclination of the vane segment increases progressively in a radially outward direction and is a maximum at the radially outermost edge 17

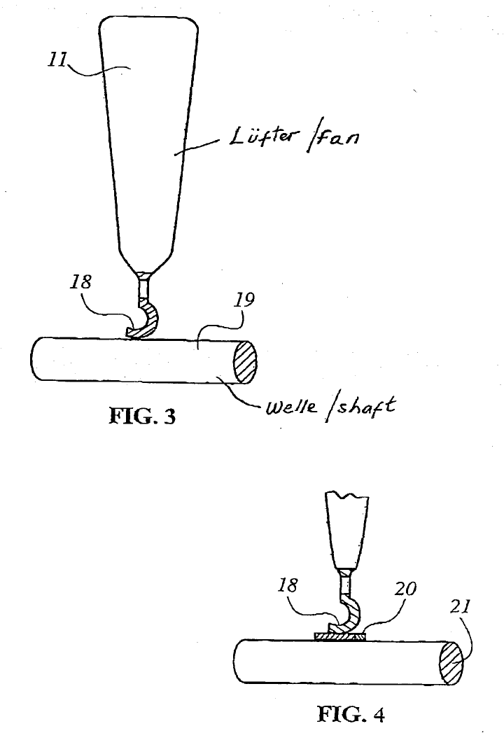

The sheet material defining the aperture 15 may be deformed during stamping to provide a cylindrical sleeve 38 which may be secured as an interference fit to a shaft 19 as shown in FIG. 3, or to a sleeve 20 associated with a shaft 21 as shown in FIG. 4.

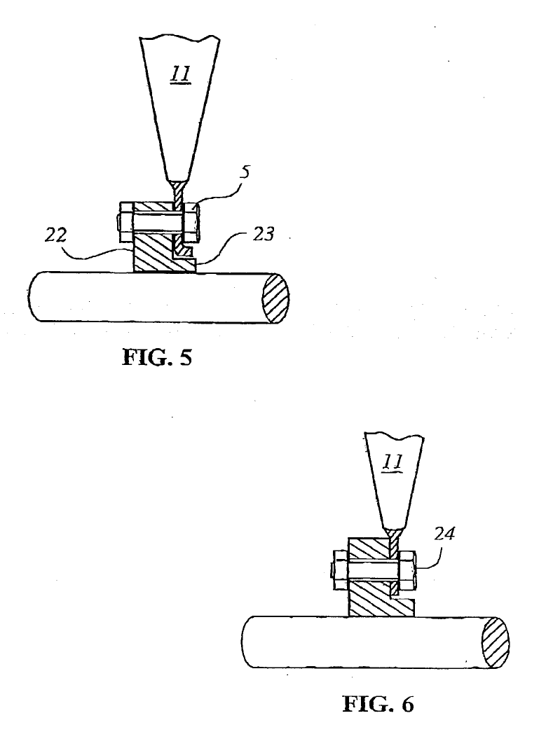

Alternatively the holes 16 may be employed to bolt the impellor to a mounting flange 22 as shown FIG. 5, with an inner edge of the impellor abutting and thus being centralised by a sleeve section 23 of the flange 22. Alternatively, as shown in FIG. 6, the radial location of the impellor and control of concentricity may be achieved by the location bolts 24.

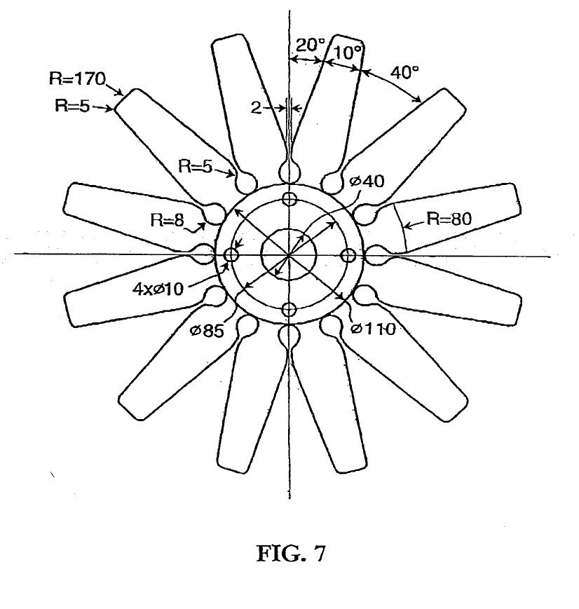

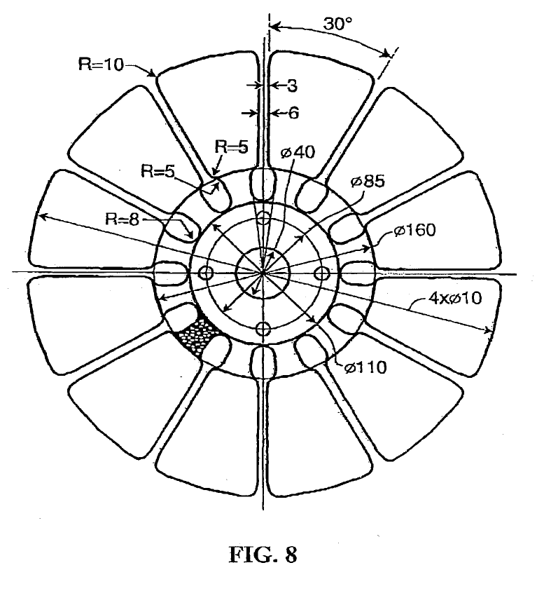

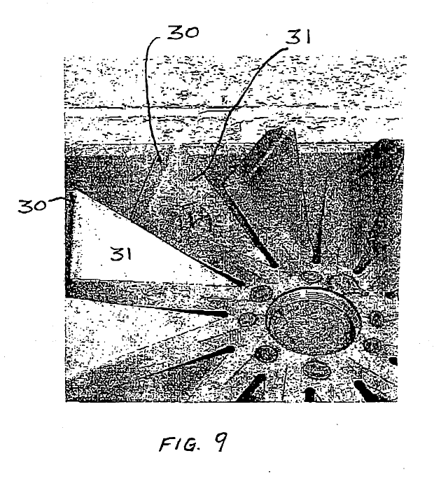

FIG. 7 and 8 are similar to FIG. 1 but show alternative shapes of vane segments and base region profiles

FIG. 9 shows an axial vane impellor in which outer end region 30 of each vane segment 31 is bent over to lie substantially perpendicular to the radial length of the segment and thereby minimise inefficient flow of air in a radially outwards direction.

1. Method for constructing an air impellor comprising providing a substantially planar sheet of plastically deformable material, forming in said sheet a plurality of cuts which each extend radially outwards from a central position defined by the intersection between said plane of the sheet material and an axis perpendicular to said plane and about which, in use, the impellor is intended to rotate, each cut extending to an outer boundary edge of the sheet material from an inner end base region which lies at a position spaced radially outwards from said central position, and then plastically deforming each segment of sheet material lying between each successive pair of cuts whereby each segment is given a twisted profile to form a vane segment in which the local angle of inclination, relative to said plane, of a circumferentially extending line on said segment increases with increasing radial distance of the circumferentially extending line from said central position.

2. Method according to claim 1, wherein each segment is given a twisted profile which lies substantially symmetrically disposed about a plane perpendicular to the axis of rotation.

3. Method according to claim 2, wherein each segment has a line of symmetry which extends rectilinearly in said plane which is perpendicular to the axis of rotation.

4. Method according to any one of claims 1 to 3, wherein each of the vanes is formed to have the same size and twist profile.

5. Method according to any one of the preceeding claims, wherein the local angle of inclination increases progressively over at least 50% of the radial length of each vane segment.

6. Method according to claim 5, wherein the local angle of inclination increases progressively over the whole of the radial length of each vane segment.

7. Method according to any one of the preceeding claims and comprising forming at least four said cuts which extend radially.

8. Method according to claim 7 and comprising forming at least twelve said cuts.

9. Method according to any one of the preceeding claims, wherein said cuts are form by a stamping operation.

10. Method according to claim 9, wherein the stamping operation to cut the sheet material simultaneously removes unwanted material from the sheet.

11. Method according to any one of the preceeding claims, wherein edges of the vanes are undercut at least at the inner and base region of each cut thereby to form the sheet material with a smooth curved profile.

12. Method according to any one of the preceeding claims, wherein a central zone of the sheet material is removed.

13. Method according to claim 12, wherein said central zone is deformed to provide a location sleeve for location of the fan on a drive shaft.

14. Method according to claim 1 and substantially as hereinbefore described.

15. An air impellor manufactured by the method according to any one of the preceding claims.

16. An air impellor comprising a sheet of plastically deformable material having a plurality of cuts which each extend radially outwards from a central position defined by the intersection between said sheet of material and an axis about which, in use, the impellor is intended to rotate, each cut extending to an outer boundary edge of the sheet material from an inner end base region which lies at a position spaced radially outwards from said central position, each vane segment thereby defined by the sheet material lying between each successive pair of cuts having a twisted profile in which the local angle of inclination of a circumferentially extending line on said vane segment, as considered relative to a plane perpendicular to said axis of rotation, increases with increasing radial distance of the circumferentially extending line from said axis of rotation.

17. An air impellor according to claim 16, wherein each segment lies substantially symmetrically disposed about a plane perpendicular to said axis of rotation.

18. An air impellor according to claim 17, wherein each segment has a line of symmetry which extends rectilinearly in said plane which is perpendicular to said axis of rotation.

19. An air impellor according to any one of claims 16 to 18, wherein each vane is of the same size and twist profile.

20. An air impellor according to any one of claims 16 to 19, wherein said local angle of inclination increases progressively over at least 50% of the radial length of each vane segment.

21. An air impellor according to claim 20, wherein said local angle of inclination increases progressively over the whole of the radial length of each vane segment.

22. An air impellor according to any one of claims 16 to 21, wherein it comprises at least four vane segments.

23. An air impellor according to claim 22 and comprising at least twelve vane segments.

24. An air impellor according to any one of claims 16 to 23, wherein the sheet material is sheet steel.

25. An air impellor according to any one of claims 16 to 24, wherein at least at the inner end base region of each cut the edges of the vanes are undercut whereby the sheet material has at that region a smooth curved profile.

26. An air impellor according to any one of claims 16 to 25, wherein a central zone of the sheet material comprises an aperture through which a drive shaft may extend and means for locating the impellor on the drive shaft.

27. An air impellor according to any one of claims 16 to 26, wherein the inclination angle of each vane segment is greater than 45 degrees over at least 50% of the radial extent of each cut.

28. An air impellor according to any one of claims 16 to 27, wherein the inclination angle is at least 80 degrees at the radially outer edge of each segment.

29. An air impellor according to any one of claims 16 to 28, wherein the vane segments lie wholly at an inclination angle less than 90 degrees.

30. An air impellor according to any one of claims 16 to 27 or claim 29, wherein a deflector is provided at the radially outer end of each vane segment to reduce the tendency in use for air to flow in a radially outwards direction.

31. An air impellor according to claim 16 and substantially as hereinbefore described.

32. A geared assembly comprising a gear train, a shaft associated with the gear train and an air impellor according to any one of claims 16 to 31 secured to said shaft.
